(19) United States
(12) Patent Application Publication
(10) Pub. No.: US 2026/0332808 A1
(43) Pub. Date: Oct. 22, 2026

(54) Method and Apparatus of Subblock-based Temporal Motion Vector Prediction with Reordering and Refinement in Video Coding

(71) Applicant: MEDIATEK INC., Hsinchu City (TW)

(72) Inventors: Yu-Ling HSIAO, Hsinchu City (TW); Chih-Wei HSU, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/997,884

(22) PCT Filed: Aug. 3, 2023
(86) PCT No.: PCT/CN2023/110903

§ 371 Date: Jan. 23, 2025

Related U.S. Application Data
(60) Provisional application No. 63/370,508, filed on Aug. 5, 2022.

(51) Int. Cl. H04N 19/52; H04N 19/176

(52) U.S. Cl. CPC H04N 19/52; H04N 19/176

(57) ABSTRACT

A method and apparatus for video coding using SbTMVP. According to the method, a target motion shift is determined from one or more neighbouring blocks comprising at least one non-adjacent spatial neighbouring block of the current block. A collocated block in a reference picture is determined based on the target motion shift. Subblock motion information is derived for subblocks of the current block based on motion information of corresponding subblocks of the collocated block. An SbTMVP candidate is generated for the current block based on the subblock motion information for the subblocks of the current block. The current block is encoded or decoded by using a motion prediction set comprising the SbTMVP candidate.

### CROSS REFERENCE TO RELATED APPLICATIONS

The present invention is a non-Provisional Application of and claims priority to U.S. Provisional Patent Application No. 63/370,508, filed on Aug. 5, 2022. The U.S. Provisional Patent Application is hereby incorporated by reference in its entirety.

### FIELD OF THE INVENTION

The present invention relates to video coding system using SbTMVP (Subblock-based Temporal Motion Vector Prediction). In particular, the present invention relates to techniques to improve the coding efficiency for SbTMVP.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Subblock-Based Temporal Motion Vector Prediction (SbTMVP) in VVC

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (i.e., the collocated block is the bottom-right or centre block relative to the current CU), SbTMVP applies a motion shift before fetching the temporal motion information from the collocated picture, where the motion shift is obtained from the motion vector from one of the spatial neighbouring blocks of the current CU.

The SbTMVP process is illustrated in FIGS. 2A-B. SbTMVP predicts the motion vectors of the sub-CUs within the current CU in two steps. In the first step, the spatial neighbour A1 in FIG. 2A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 2B. The example in FIG. 2B assumes the motion shift is set to block A1's motion, where frame 220 corresponds to the current picture and frame 230 corresponds to a reference picture (i.e., a collocated picture). Then, for each sub-CU, the motion information of its corresponding block (the smallest motion grid that covers the centre sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU. In FIG. 2B, the arrow(s) in each subblock of the collocated picture 230 correspond(s) to the motion vector(s) of a collocated subblock (thick-lined arrow for L0 MV and thin-lined arrow for L1 MV). For the current picture 220, the arrow(s) in each subblock correspond(s) to the scaled motion vector(s) of a current subblock (thick-lined arrow for L0 MV and thin-lined arrow for L1 MV). If no motion information of the collocated sub-CU is available (e.g. an intra coded subblock), a default motion is used.

In VVC, a combined subblock based merge list, which contains both SbTMVP candidate and affine merge candidates, is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for the affine merge mode, SbTMVP mode is only applicable to the CU with both width and height are larger than or equal to 8.

The encoding processing flow of the additional SbTMVP merge candidate is the same as for the other merge candidates, that is, for each CU in P or B slice, an additional RD check is performed to decide whether to use the SbTMVP candidate.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 3. The distances between non-adjacent spatial candidates and current coding block are based on the width and height of current coding block. In FIG. 3, each small numbered box corresponds to a NAMVP candidate and the candidates are ordered (as shown by the number inside the square) according to the distance.

### Multi-Pass Decoder-Side Motion Vector Refinement (MP-DMVR)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### First Pass—Block Based Bilateral Matching MV Refinement

In the first pass, a refined MV is derived by applying BM to a coding block. Similar to decoder-side motion vector refinement (DMVR), in the bi-prediction operation, a refined MV is searched around the two initial MVs (i.e., MV0 and MV1) in the reference picture lists L0 and L1. The refined MVs (i.e., MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in the horizontal direction and [−sVer, sVer] in the vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the centre point of the 3×3 search pattern has the minimum cost, the intDeltaMV local search is terminated. Otherwise, the current minimum cost search point becomes the new centre point of the 3×3 search pattern and continue to search for the minimum cost, until it reaches the end of the search range.

The existing fractional sample refinement is further applied to derive the final deltaMV. The refined MVs after the first pass are then derived as:

MV0_pass1=MV0+deltaMV

MV1_pass1=MV1−deltaMV

### Second Pass—Subblock Based Bilateral Matching MV Refinement

In the second pass, a refined MV is derived by applying BM to a 16×16 grid subblock. For each subblock, a refined MV is searched around the two MVs (e.g. MV0_pass1 and MV1_pass1), obtained during the first pass, in the reference picture list L0 and L1. The refined MVs (i.e., MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in the horizontal direction and [−sVer, sVer] in the vertical direction, wherein, the values of sHor and s Ver are determined by the block dimension, and the maximum value of sHor and sVer is 8.

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 4, where the 5 search regions are shown in 5 different shades. Each search region is assigned a costFactor, which is determined by the distance (intDeltaMV) between each search point and the starting MV, and each diamond region is processed in the order starting from the centre of the search area. In each region, the search points are processed in the raster scan order starting from the top left going to the bottom right corner of the region. When the minimum bilCost within the current search region is less than a threshold equal to sbW * sbH, the int-pel full search is terminated; otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbIdx2). The refined MVs at second pass is then derived as:

MV0_pass2(sbIdx2)=MV0_pass1+deltaMV (sbIdx2)·

MV1_pass2(sbIdx2)=MV1_pass1−deltaMV (sbIdx2)

### Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (e.g. MV0_pass3(sbIdx3) and MV1_pass3(sbIdx3)) at third pass are derived as:

MV0_pass3(sbIdx3)=MV0_pass2(sbIdx2)+bioMv

MV1_pass3(sbIdx3)=MV0_pass2(sbIdx2)−bioMv

### Adaptive Decoder-Side Motion Vector Refinement

Adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e. PU level) DMVR.

The merge candidates for the new merge mode are derived from spatial neighbouring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### Template Matching for MV Refinement

Template matching (TM) is a decoder-side MV derivation method to refine the motion information of the current CU by finding the closest match between a template (i.e., top 514 and/or left 516 neighbouring blocks of the current CU 512) in the current picture 510 and a block (i.e., same size to the template, block 524 and 526) in a reference picture 520 as shown in FIG. 5. In FIG. 5, a better MV is searched around the initial motion 530 of the current CU 512 of the current picture 510 within a [−8, +8]-pel search range 522 around location 528 in the reference picture 520 as pointed by the initial MV 530. The template matching method in JVET-J0021 (Yi-Wen Chen, et al., “Description of SDR, HDR and 360° video coding technology proposal by Qualcomm and Technicolor-low and high complexity versions”, Joint Collaborative Team on Video Coding (JCT-VC) of ITU-T SG16 WP3 and ISO/IEC JTC 1/SC 29/WG11, 10th Meeting: San Diego, US, 10-20 Apr. 2018, Document: JVET-J0021) is used with the following modifications: search step size is determined based on AMVR mode and TM can be cascaded with bilateral matching process in merge modes.

In the AMVP mode, an MVP candidate is determined based on the template matching error to select the one which reaches the minimum difference between the current block template and the reference block template. TM is then performed only for this particular MVP candidate for MV refinement. TM refines this MVP candidate by using iterative diamond search starting from full-pel MVD precision (or 4-pel for 4-pel AMVR mode) within a [−8, +8]-pel search range. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

TABLE 1
Search patterns of AMVR and merge mode with AMVR.

| | AMVR mode | | | | Merge mode | |
|---|---|---|---|---|---|---|
| Search pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In the merge mode, similar search method is applied to the merge candidate indicated by the merge index. As shown in Table 1, TM may be performed all the way down to 1/8-pel MVD precision or skipping those beyond half-pel MVD precision, depending on whether the alternative interpolation filter (used for AMVR being a half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

Adaptive Reordering of Merge Candidates with Template Matching (ARMC-TM)

The merge candidates are adaptively reordered according to costs evaluated using template matching (TM). The reordering method can be applied to the regular merge mode, template matching (TM) merge mode, and affine merge mode (excluding the SbTMVP candidate). For the TM merge mode, merge candidates are reordered before the refinement process.

After a merge candidate list is constructed, merge candidates are divided into multiple subgroups. The subgroup size is set to 5 for the regular merge mode and TM merge mode. The subgroup size is set to 3 for the affine merge mode. Merge candidates in each subgroup are reordered ascendingly according to cost values based on template matching. For ARMC-TM, the candidates in a subgroup are skipped if the subgroup satisfies the following 2 conditions: (1) the subgroup is the last subgroup and (2) the subgroup is not the first subgroup. For simplification, merge candidates in the last, but not the first subgroup, are not reordered.

The template matching cost of a merge candidate is measured as the sum of absolute differences (SAD) between samples of a template of the current block and their corresponding reference samples. The template comprises a set of reconstructed samples neighbouring to the current block. Reference samples of the template are located by the motion information of the merge candidate.

When a merge candidate utilizes bi-directional prediction, the reference samples of the template of the merge candidate are also generated by bi-prediction as shown in FIG. 6. In FIG. 6, block 612 corresponds to a current block in current picture 610, blocks 622 and 632 correspond to reference blocks in reference pictures 620 and 630 in list 0 and list 1 respectively. Templates 614 and 616 are for current block 612, templates 624 and 626 are for reference block 622, and templates 634 and 636 are for reference block 632. Motion vectors 640, 642 and 644 are merge candidates in list 0 and motion vectors 660, 662 and 664 are merge candidates in list 1.

For subblock-based merge candidates with subblock size equal to Wsub×Hsub, the above template comprises several sub-templates with the size of Wsub×1, and the left template comprises several sub-templates with the size of 1×Hsub. As shown in FIG. 7, the motion information of the subblocks in the first row and the first column of current block is used to derive the reference samples of each sub-template. In FIG. 7, block 712 corresponds to a current block in current picture 710 and block 722 corresponds to a collocated block in reference picture 720. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks.

In the present invention, schemes to further improve the performance for SbTMVP are disclosed.

### BRIEF SUMMARY OF THE INVENTION

A method and apparatus for video coding using SbTMVP (Subblock-based Temporal Motion Vector Prediction) are disclosed. According to the method, input data associated with a current block are received, where the input data comprise pixel data for the current block to be encoded at an encoder side or encoded data associated with the current block to be decoded at a decoder side. A target motion shift is determined from one or more neighbouring blocks comprising at least one non-adjacent spatial neighbouring block of the current block. A collocated block in a reference picture is determined based on the target motion shift. Subblock motion information is derived for subblocks of the current block based on motion information of corresponding subblocks of the collocated block. An SbTMVP candidate is generated for the current block based on the subblock motion information for the subblocks of the current block. The current block is encoded or decoded by using a motion prediction set comprising the SbTMVP candidate.

In one embodiment, the SbTMVP candidate is used for Skip mode, Merge mode, Direct mode, Intra mode, Inter mode, IBC mode or a combination thereof.

In one embodiment, the target motion shift is derived from one or more motion shift candidates from said one or more neighbouring blocks based on one or more schemes involved with TM (Template Matching), ARMC-TM (Adaptive Reordering of Merge Candidates with Template Matching) or both. In one embodiment, the target motion shift is derived by refining one motion shift candidate based on the TM with one or more templates of the current block. In another embodiment, two or more motion shift candidates from one or more neighbouring adjacent blocks of the current block, one or more neighbouring non-adjacent blocks of the current block or both are determined, and wherein said two or more motion shift candidates are reordered according to the ARMC-TM. In one embodiment, a first motion shift candidate in reordered two or more motion shift candidates is selected as the target motion shift. In another embodiment, a first motion shift candidate in reordered two or more motion shift candidates is refined by the TM and used as the target motion shift.

In one embodiment, two or more motion shift candidates from one or more neighbouring adjacent blocks of the current block, one or more neighbouring non-adjacent blocks of the current block or both are determined, and wherein said two or more motion shift candidates are refined according to the TM and then reordered according to the ARMC-TM. In one embodiment, a first motion shift candidate in reordered two or more motion shift candidates is selected as the target motion shift. In another embodiment, if one motion shift candidate from said two or more motion shift candidates points to one collocated block without valid motion information, a TM cost or ARMC-TM cost for said one motion shift candidate is set to a large value so that said one motion shift candidate is skipped from being selected as the target motion shift.

In one embodiment, if the subblock motion information for a target subblock is not available, a default motion is refined by the TM or BM (Bilateral Matching) and used as the subblock motion information for the target subblock. In another embodiment, if the subblock motion information for the target subblock is not available, the default motion is refined by the TM with one or more templates of the current block. In yet another embodiment, if the subblock motion information for the target subblock is not available, the default motion is refined by the BM. In yet another embodiment, if the subblock motion information for the target subblock is not available, the default motion is refined by the TM and then by the BM. In yet another embodiment, if the subblock motion information for the target subblock is not available, the default motion is refined by the BM and then by the TM.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2A illustrates an example of subblock-based Temporal Motion Vector Prediction (SbTMVP) in VVC, where the spatial neighbouring blocks are checked for availability of motion information.

FIG. 2B illustrates an example of SbTMVP for deriving sub-CU motion field by applying a motion shift from spatial neighbour and scaling the motion information from the corresponding collocated sub-CUs.

FIG. 3 illustrates an exemplary pattern of the non-adjacent spatial merge candidates.

FIG. 4 illustrates the 5 diamond shape search regions used for multi-pass decoder-side motion vector refinement.

FIG. 5 illustrates an example of template matching used to refine an initial MV by searching an area around the initial MV.

FIG. 6 illustrates an example of templates used for the current block and corresponding reference blocks to measure matching costs associated with merge candidates.

FIG. 7 illustrates an example of template and reference samples of the template for block with subblock motion using the motion information of the subblocks of the current block.

FIG. 8 illustrates a flowchart of an exemplary video coding system that utilizes SbTMVP with motion shift derived from one or more neighbouring blocks including at least one non-adjacent neighbouring block according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

As mentioned earlier, in the conventional SbTMVP, the motion shift used to locate a temporal collocated block. The motion information of the collocated block is then used to derive the motion information for the subblocks of the current block. The motion shift is determined from a spatial neighbouring block. To improve coding efficiency of SbTMVP for Skip, Merge, Direct, Intra modes, Inter modes, and/or IBC modes, the following schemes are disclosed.

In one embodiment, a motion vector of non-adjacent spatial neighbouring blocks is used as motion shift. In the conventional approach, only adjacent neighbouring blocks are used for deriving the motion shift. If no motion information is available from neighbouring block (e.g. none of the spatial neighbouring blocks being intra coded), the motion shift is set to (0, 0), which may not provide a good prediction. Therefore, the present invention proposes to allow motion information from one or more non-adjacent neighbouring blocks being used for deriving the motion shift. The motion shift based on non-adjacent spatial neighbouring blocks is expected to provide a better prediction.

In one embodiment, the motion shift derivation is related to TM and/or ARMC-TM. Some examples are listed as follows, however, the present invention is not limited to these examples:
A motion shift is refined by TM with CU template.
Two or more motion vector of adjacent and/or non-adjacent spatial neighbouring blocks are reordered by ARMC-TM, then select the first one or more as the motion shift. As is known for ARMC-TM, the reordering is performed according to the template matching cost associated with said two or more motion vectors. The candidates are reordered with the smallest template matching cost first. In other words, the one with the smallest template matching cost is selected.
Two or more motion vector of adjacent and/or non-adjacent spatial neighbouring blocks are refined by TM, then reordered by ARMC-TM, then select the first one or more as the motion shift.
Two or more motion vector of adjacent and/or non-adjacent spatial neighbouring blocks are reordered by ARMC-TM, then select the first one or more as motion shift and then refined by TM.
In the process of TM or ARMC-TM, set the cost of TM or ARMC-TM associated with a motion vector to a large value or skip a motion vector if treating the motion vector as a motion shift would make a SbTMVP candidate not available (i.e., the default motion is not available).

In one embodiment, the default motion is further refined by TM and/or BM:
A default motion is refined by TM with CU template.
A default motion is refined by BM.
A default motion is refined by TM and then BM.
A default motion is refined by BM and then TM.

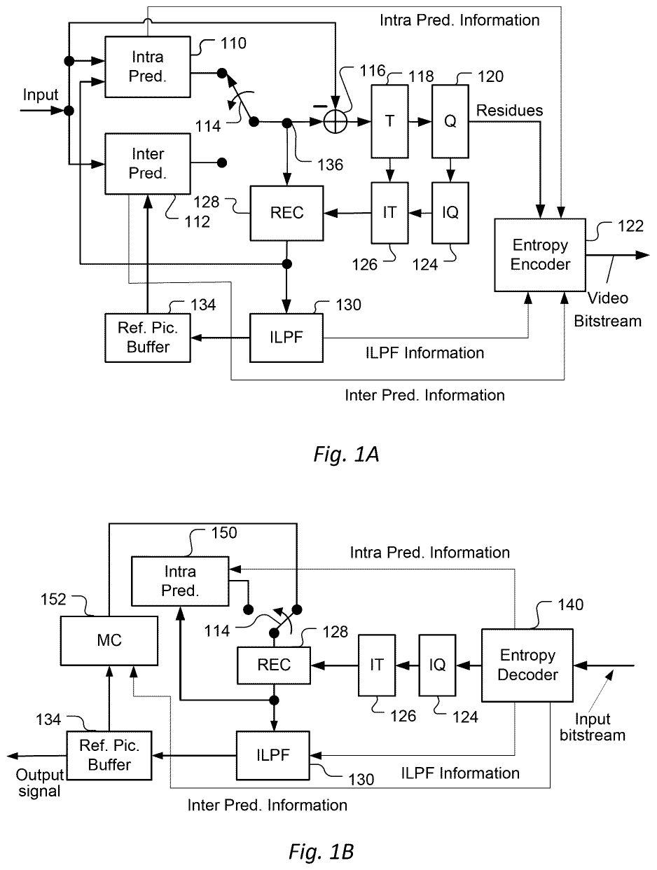

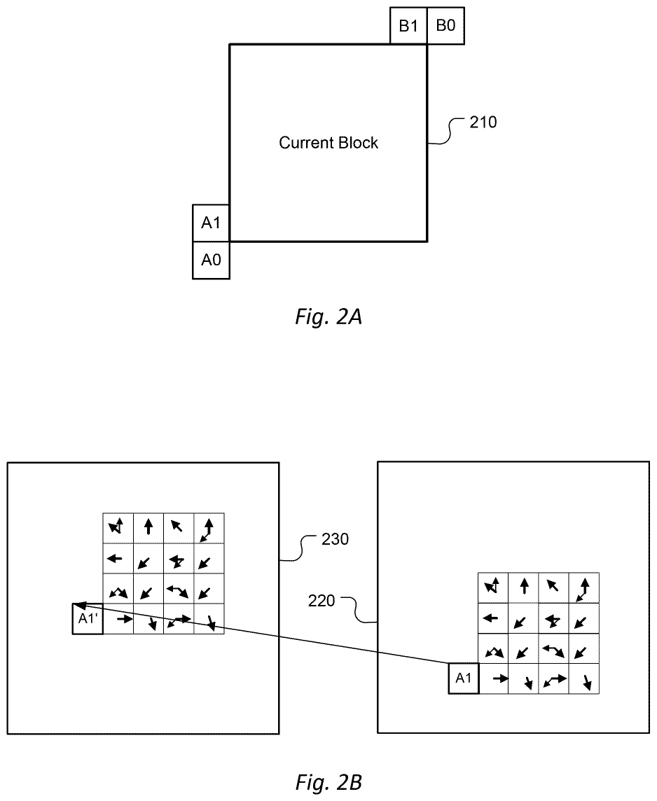

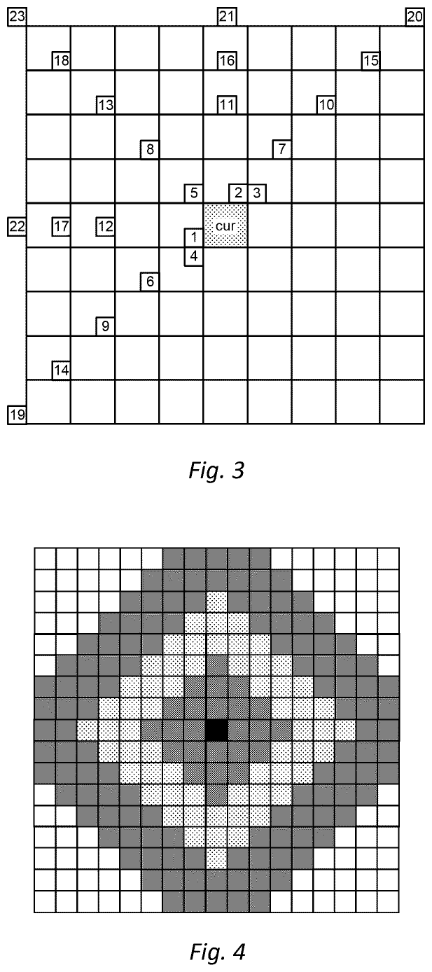

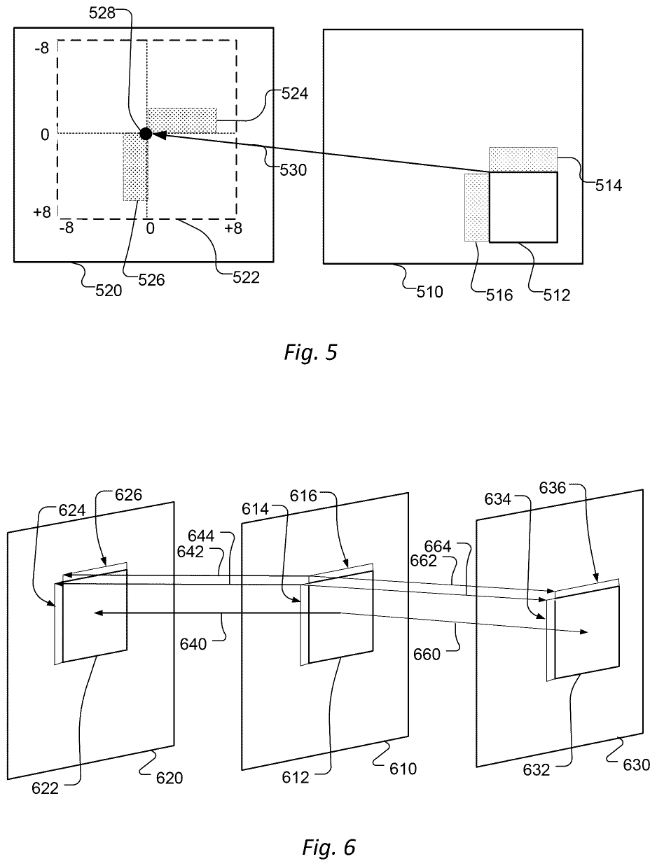

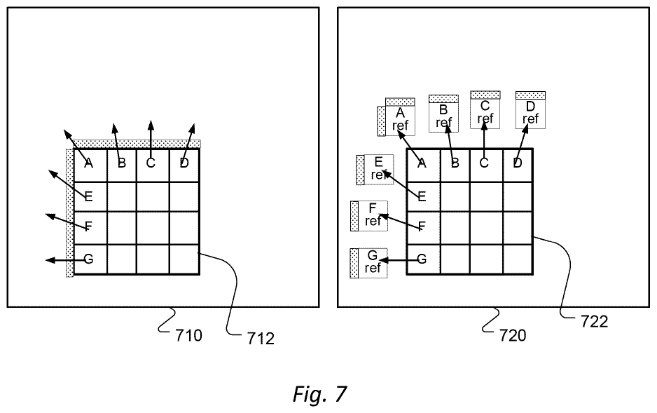

Any of the SbTMVP methods with motion shift derived from one or more neighbouring blocks including at least one non-adjacent neighbouring block a described above can be implemented in encoders and/or decoders. For example, any of the proposed SbTMVP methods can be implemented in an inter coding module and/or a merge/AMVP candidate derivation module of an encoder (e.g. Inter Pred. 112 in FIG. 1A), or a motion compensation module (e.g., MC 152 in FIG. 1B) and/or a merge/AMVP candidate derivation module of a decoder. Alternatively, any of the proposed methods can be implemented as a circuit coupled to the inter coding module and/or a merge/AMVP candidate derivation module of an encoder and/or motion compensation module and/or a merge/AMVP candidate derivation module of the decoder. While the Inter-Pred. 112 and MC 152 are shown as individual processing units to support the SbTMVP methods, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

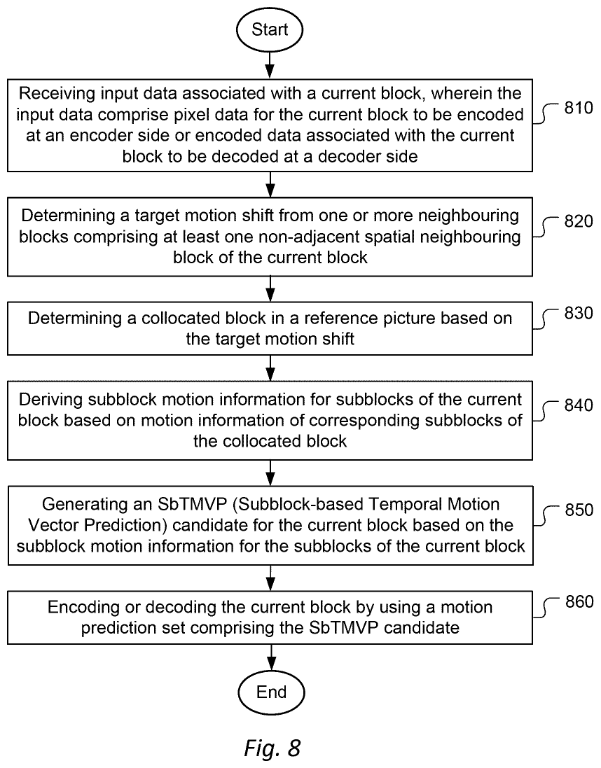

FIG. 8 illustrates a flowchart of an exemplary video coding system that utilizes SbTMVP with motion shift derived from one or more neighbouring blocks including at least one non-adjacent neighbouring block according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 810, wherein the input data comprise pixel data for the current block to be encoded at an encoder side or encoded data associated with the current block to be decoded at a decoder side. A target motion shift is determined from one or more neighbouring blocks comprising at least one non-adjacent spatial neighbouring block of the current block in step 820. A collocated block in a reference picture is determined based on the target motion shift in step 830. Subblock motion information is derived for subblocks of the current block based on motion information of corresponding subblocks of the collocated block in step 840. An SbTMVP candidate is generated for the current block based on the subblock motion information for the subblocks of the current block in step 850. The current block is encoded or decoded by using a motion prediction set comprising the SbTMVP candidate in step 860.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or encoded data associated with the current block to be decoded at a decoder side;
determining a target motion shift from one or more neighbouring blocks comprising at least one non-adjacent spatial neighbouring block of the current block;
determining a collocated block in a reference picture based on the target motion shift;
deriving subblock motion information for subblocks of the current block based on motion information of corresponding subblocks of the collocated block;
generating an SbTMVP (Subblock-based Temporal Motion Vector Prediction) candidate for the current block based on the subblock motion information for the subblocks of the current block; and
encoding or decoding the current block by using a motion prediction set comprising the SbTMVP candidate.

2. The method of claim 1, wherein the SbTMVP candidate is used for Skip mode, Merge mode, Direct mode, Inter mode, IBC mode or a combination thereof.

3. The method of claim 1, wherein the target motion shift is derived from one or more motion shift candidates from said one or more neighbouring blocks based on one or more schemes involved with TM (Template Matching), ARMC-TM (Adaptive Reordering of Merge Candidates with Template Matching) or both.

4. The method of claim 3, wherein the target motion shift is derived by refining one motion shift candidate based on the TM with one or more templates of the current block.

5. The method of claim 3, wherein two or more motion shift candidates from one or more neighbouring adjacent blocks of the current block, one or more neighbouring non-adjacent blocks of the current block or both are determined, and wherein said two or more motion shift candidates are reordered according to the ARMC-TM.

6. The method of claim 5, wherein a first motion shift candidate in reordered two or more motion shift candidates is selected as the target motion shift.

7. The method of claim 5, wherein a first motion shift candidate in reordered two or more motion shift candidates is refined by the TM and used as the target motion shift.

8. The method of claim 3, wherein two or more motion shift candidates from one or more neighbouring adjacent blocks of the current block, one or more neighbouring non-adjacent blocks of the current block or both are determined, and wherein said two or more motion shift candidates are refined according to the TM and then reordered according to the ARMC-TM.

9. The method of claim 8, wherein a first motion shift candidate in reordered two or more motion shift candidates is selected as the target motion shift.

10. The method of claim 8, wherein if one motion shift candidate from said two or more motion shift candidates points to one collocated block without valid motion information, a TM cost or ARMC-TM cost for said one motion shift candidate is set to a large value so that said one motion shift candidate is skipped from being selected as the target motion shift.

11. The method of claim 1, wherein if the subblock motion information for a target subblock is not available, a default motion is refined by the TM or BM (Bilateral Matching) and used as the subblock motion information for the target subblock.

12. The method of claim 11, wherein if the subblock motion information for the target subblock is not available, the default motion is refined by the TM with one or more templates of the current block.

13. The method of claim 11, wherein if the subblock motion information for the target subblock is not available, the default motion is refined by the BM.

14. The method of claim 11, wherein if the subblock motion information for the target subblock is not available, the default motion is refined by the TM and then by the BM.

15. The method of claim 11, wherein if the subblock motion information for the target subblock is not available, the default motion is refined by the BM and then by the TM.

16. An apparatus for video coding using MVP (Motion Vector Prediction), the apparatus comprising one or more electronics or processors arranged to:
receive input data associated with a current block, wherein the input data comprise pixel data for the current block to be encoded at an encoder side or prediction residual data associated with the current block to be decoded at a decoder side;
determine a target motion shift from one or more neighbouring blocks comprising at least one non-adjacent spatial neighbouring block of the current block;
determine a collocated block in a reference picture based on the target motion shift;
derive subblock motion information for subblocks of the current block based on motion information of corresponding subblocks of the collocated block;
generate an SbTMVP (Subblock-based Temporal Motion Vector Prediction) candidate for the current block based on the subblock motion information for the subblocks of the current block; and
encode or decode the current block by using a motion prediction set comprising the SbTMVP candidate.
